(19) United States
(12) Patent Application Publication
(10) Pub. No.: US 2006/0027494 A1
(43) Pub. Date: Feb. 9, 2006

(54) Oil treated filter media

(75) Inventor: Kyung-Ju Choi, Louisville, KY (US)

Correspondence Address: JOHN F. SALAZAR;MIDDLETON & REUTLINGER, 2500 BROWN & WILLIAMSON TOWER, LOUISVILLE, KY, 40202, US

(73) Assignee: AAF-McQuay, Inc., A Kentucky Corporation, Louisville, KY (US)

(21) Appl. No.: 11/246,389

(22) Filed: Oct. 7, 2005

Related U.S. Application Data
(63) Continuation-in-part of application No. 10/669,963, filed on Sep. 24, 2003.
Application No. 10/669,963 is a continuation of application No. 09/633,922, filed on Aug. 8, 2000, now Pat. No. 6,652,748.
Application No. 09/633,922 is a continuation-in-part of application No. 09/236,207, filed on Jan. 23, 1999, now abandoned.

(51) Int. Cl. B01D 39/00

(52) U.S. Cl. 210/508

(57) ABSTRACT

A filter medium treated by a novel adhesive comprised of a major portion by weight of an oil group consisting of vegetable, animal, or mineral oils and a minor portion of a thickening material.

### CROSS-REFERENCE TO RELATED APPLICATIONS

This is a continuation-in-part of co-pending application Ser. No. 10/669,963, filed Sep. 24, 2003, which is a continuation of application Ser. No. 09/633,992, filed Aug. 8, 2000, now U.S. Pat. No. 6,652,748, which is a continuation-in-part of application Ser. No. 09/236,207, filed Jan. 23, 1999, now abandoned, each of which are incorporated herein by reference.

### BACKGROUND OF THE INVENTION

1. Field of the Invention

The present invention relates to a unique and novel filter media and more particularly to a unique adhesive treatment for filter media.

2. Description of the Related Art

It has been long known in the filtering art that in order to provide a viscous impingement fibrous filter, a suitable adhesive medium should be used on the filter media. In this regard, attention is directed to. U.S. Pat. No. 4,608,173, issued to K. Watanabe et. al. on Aug. 26, 1986, which teaches a cationic polyacrylide coating on filter fibers; U.S. Pat. No. 5,124,177 issued to J. W. Kasmark, Jr. et. al. on Jun. 23, 1992, which teaches the use of one of several organic adhesives, such as an organic latex or acetate combined with activated odor removing particles, such as carbon or silica gel; U.S. Pat. No. 5,269,925, issued to T. E. Broadhurst on Dec. 14, 1993, which teaches the use of mineral coated fibers with grit added to provide surface roughness; U.S. Pat. No. 5,338,340, issued to J. W. Kasmark, Jr. et. al. on Aug. 16, 1994, which teaches the use of an organic, synthetic coating substance such as latex or an acetate combined with odor-removing activated particles, such as carbon or silica gel and the like, and, U.S. Pat. No. 5,525,136, issued to R. M. Rosen on Jun. 11, 1996, which teaches the use of oils, including vegetable oil, as a fibrous filter coating.

In accordance with the present invention, a new and useful fibrous filter media coating is provided which greatly improves filtration efficiency of certain particle sizes, which is comparatively inexpensive to make, install and use in a straightforward manner, which has a high system performance efficiency and integrity and, which minimizes liberation of respiratory irritating gases—an undesirable fault common to filtering gases or breathing air with some past adhesives. Various other features of the present invention will become obvious to one skilled in the art upon reading the disclosure set forth herein.

### SUMMARY OF THE INVENTION

In accordance with the present invention, a novel medium for removing particulates from a gas stream is provided. The filter medium comprises a porous fiber filter medium and an adhesive coating therefore selected from a percentage mixture of a major portion of an oil group consisting of vegetable, agricultural, mineral or animal oils and a minor portion of a thickening material.

It is to be understood that various changes can be made by one skilled in the art in one or more of the several parts of the filter arrangements disclosed herein without departing from the scope or spirit of the present invention.

### BRIEF DESCRIPTION OF THE DRAWINGS

Referring to the drawings which discloses advantageous embodiments of the present invention:

FIG. 1 is a filtration efficiency representative graph comparing the filtration efficiency, at particle sizes of more than 0.3 micrometers of a filter medium treated with a herein disclosed inventive adhesive with the filtration efficiencies of four other filter media, three filter media of which were each treated with the same adhesive amounts of one of three known commercial adhesives and a fourth filter medium which was not treated.

FIG. 2 is a filtration efficiency representative graph comparing the filtration efficiency, at particle sizes of more than 0.3 micrometers of a filter medium treated with an adhesive comprising mineral oil and a fumed silica thickener at selected concentrations providing selected viscosities, with the filtration efficiency of a filter medium which was not treated.

### DETAILED DESCRIPTION

In accordance with the present invention, filter medium sheets are coatingly treated with one or more of the novel adhesive oils in combination with a thickener of the present invention in order to obtain an improved filter efficiency and dust holding capacity with comparatively minimal initial resistance or static pressure drop across the treated filter media. The present invention provides for treating anyone of several known fibrous filter media such as, but not limited to, spun or chopped glass fibers, synthetic fibers or natural fibers. The filter media is coated with a novel adhesive coating selected from a percentage mixture of a major portion of an oil group and a minor portion of thickener material, and optionally with other additives such as anti-oxidants and flame retardants. The oil is chosen from the group consisting of vegetable, agricultural, mineral and animal oils. The thickener material serves as an oil thickener to increase flow resistance. The adhesive coating mixture comprises an oil group in the range of at least 90% by weight of said mixture or oil and a thickener in the range of at most 10% by weight of the mixture and advantageously an oil group of approximately 95% by weight of the mixture and a thickener of approximately 5% by weight of the mixture. The adhesive, including at least one oil of the group and a thickener, can desirably have a viscosity flow rate in the range of 0.5 to 500 poise and advantageously approximately 12.5 poise. The oil of the group can be one or a combination of oils extracted from soybean, corn, cotton seed, sunflower seed, safflower, canola, nut, sesame, olives, apricots, grape seeds, palm cedar, seal, mink, fish or other fatty oils or mineral oil advantageously with a molecular formula CH₃(CH₂)nCH₃, commercially available under the trade name “Avatech”, from Avatar Corporation, 500 Central Avenue, University Park, Ill., 60466. The thickener of the minor portion has fumed silica and optionally additional thickener(s) chosen from the group consisting of treated clay, inorganic powder or a polymeric material or a mixture by weight of the same, with the thickener and oil having a viscosity in the range of 0.5-500 poise, advantageously at approximately 12.5 poise. Fumed silica is silicon dioxide with unique properties and is commonly added to liquids/coatings and solids to improve various properties, in this case the desired property is viscosity. Fumed silica has a chain-like particle morphology where the chains bond together in a liquid such as oil via weak hydrogen bonding. This property causes the fumed silica to be miscible in the oils disclosed herein and acts as a thickening agent therein. Fumed silica is typically produced with a continuous flame hydrolysis technique.

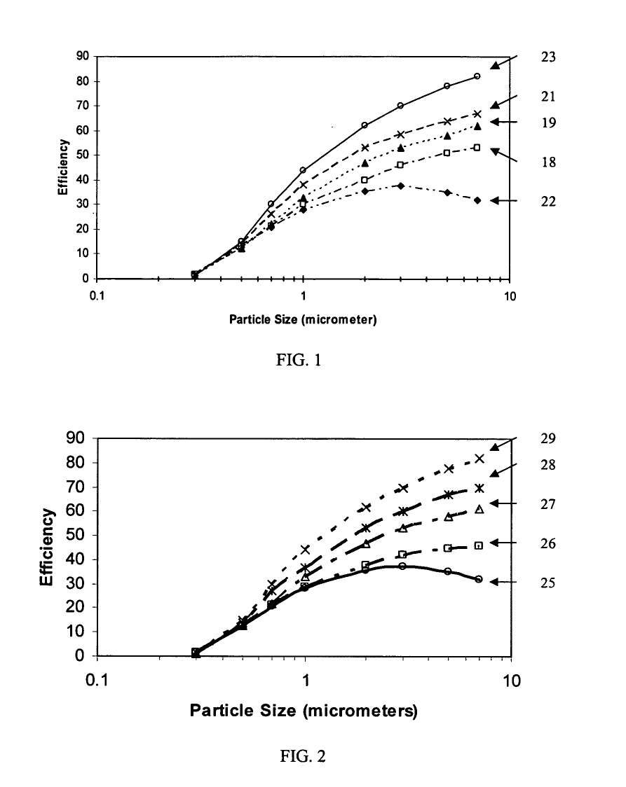

Referring to the representative efficiency graph in FIG. 1 of the drawings, curves are shown, which plot and compare the relative efficiencies of five (5) identical filter media. Three (3) of the curves represent identical media which were treated, as above described, separately with three commercially available different adhesives, namely a commercial adhesive known as chlorinated paraffin and designated by the rectangular mark and reference numeral 18, a commercial adhesive known as polybutene and designated by the triangular mark and reference numeral 19, and, a commercial adhesive known as petroleum hydrocarbon and designated by the cross mark and reference numeral 21. A fourth curve designated by the diamond mark and reference numeral 22 represents an identical filter media which was untreated and which does, in fact, show the lowest efficiency. The fifth curve designated by the circular mark and reference numeral 23 shows the highest efficiency of all. It was treated by an inventive adhesive of a mixture of ninety-five (95) percent by weight of soybean oil and five (5) percent by weight of fumed silica.

Referring to the representative efficiency graph in FIG. 2 of the drawings, curves are shown, which plot and compare the relative efficiencies of five (5) identical filter media. Four (4) of the curves represent identical media which were treated, as above described, separately with an adhesive of the present invention having mineral oil and fumed silica at different concentrations providing alternate viscosities. An adhesive comprised of mineral oil and fumed silica wherein the fumed silica is in an amount providing the adhesive with a viscosity of approximately 1 poise is designated by the rectangular mark and reference numeral 26, an alternative adhesive having mineral oil and an amount of fused silica necessary to provide a viscosity of approximately 6.5 poise is designated by the triangular mark and reference numeral 27, and, another adhesive having mineral oil and an amount of fused silica necessary to provide a viscosity of approximately 15 and designated by the star mark and reference numeral 28. A fourth curve designated by the circular mark and reference numeral 25 represents an identical filter media which was untreated and which does, in fact, show the lowest efficiency. The fifth curve designated by the cross mark and reference numeral 29 shows the highest efficiency of all. It was treated by an inventive adhesive of a mixture of mineral oil and an amount of fumed silica necessary to provide an adhesive with a viscosity of approximately 12.5 poise.

I claim:

1. A filter medium for removing particulates from a gas stream comprising: a porous fiber filter medium and an adhesive coating therefore; the adhesive coating comprising a major portion by weight of an oil group and a minor portion by weight of a thickener; the oil of the oil group being chosen from the group consisting of vegetable, agricultural, mineral and animal oils and including one or a combination of oils extracted from soybean, corn, cottonseed, sunflower seed, safflower, nut, sesame, olives, apricots, grape seeds, palm, cedar, seal, fish, fatty oils or mink; the thickener having fumed silica and optionally one or a combination of thickeners chosen from a group including treated clay, inorganic powder, polymeric materials, or a combination thereof.

2. The filter medium of claim 1, wherein said adhesive coating comprises at least 90% by weight of said oil and at most 10% by weight of said thickener.

3. The filter medium of claim 1, wherein said adhesive coating mixture comprises approximately 95% percent by weight of said oil and approximately 5% by weight of said thickener.

4. The filter medium of claim 1, wherein said oil is:
a) soybean oil;
b) corn oil;
c) cottonseed oil;
d) sunflower oil;
e) safflower oil;
f) nut oil;
g) sesame oil;
h) an olive oil;
i) canola oil;
j) an apricot oil;
k) a grape seed oil;
l) palm oil;
m) cedar oil;
n) seal oil;
o) fish oil;
p) mink oil;
q) fatty oil; or
r) mineral oil

5. The filter medium of claim 1, wherein said oil is chosen from the group consisting of soybean, corn, cottonseed, sunflower seed, almond, sesame, olives, apricots, grape seeds, palm, cedar, seal, cod, mink, mineral oil and combinations thereof.

6. The filter medium of claim 1, said thickener is substantially comprised of fumed silica.

7. The filter medium of claim 1, wherein said adhesive coating has a viscosity in the range of 0.5-500 poise.

8. The filter medium of claim 1, wherein said adhesive coating has a viscosity of approximately 12.5 poise.

9. An adhesive coating mixture for a filter improving the removal of particulates from a gas stream comprising a major portion of oil and a minor portion of thickener, said thickener comprising fumed silica.

10. The adhesive coating mixture of claim 9 wherein said oil is selected from the group consisting of vegetable, agricultural, mineral, animal oils, and combinations thereof.

11. The adhesive coating mixture of claim 9 wherein said oil is selected from the group consisting of oils extracted from soybean, corn, cotton seed, sunflower seed, safflower, canola, nut, sesame, olives, apricots, grape seeds, palm cedar, seal, mink, fish or other fatty oils, mineral oil, and combinations thereof.

12. The adhesive coating mixture of claim 9 wherein said oil has a molecular formula of CH₃(CH₂)nCH₃.

13. The adhesive coating mixture of claim 9 wherein said thickener additionally comprises one or a combination of thickeners chosen from a group including treated clay, inorganic powder, polymeric materials, or combinations thereof.

14. The adhesive coating mixture of claim 9 wherein said adhesive coating has at least one additive.

15. The adhesive coating mixture of claim 14 wherein said at least one additive has a flame retardant.

16. The adhesive coating mixture of claim 14 wherein said at least one additive has an anti-oxidant.

17. The adhesive coating mixture of claim 9 wherein said major portion of oil makes up at least 90% of said adhesive coating mixture.

18. The adhesive coating mixture of claim 9 wherein said major portion of oil makes up approximately 95% of said adhesive coating mixture.

19. The adhesive coating mixture of claim 9 wherein said minor portion of said thickener makes up at most 10% of said adhesive coating mixture.

20. The adhesive coating mixture of claim 9 wherein said minor portion of said thickener makes up approximately 5% of said adhesive coating mixture.

21. The adhesive coating mixture of claim 9 wherein said adhesive coating mixture has a viscosity in the range of 0.5 to 500 poise.

22. The adhesive coating mixture of claim 9 wherein said adhesive coating mixture has a viscosity of approximately 12.5 poise.

23. The adhesive coating mixture of claim 9 wherein said adhesive coating has said minor portion of thickener being substantially fumed silica in an amount necessary to provide a viscosity in the range of 0.5 to 500 poise.

24. The adhesive coating mixture of claim 9 wherein said adhesive coating has said minor portion of thickener being substantially fumed silica in an amount necessary to provide a viscosity of approximately 12.5.

25. An adhesive coating mixture for a filter improving the removal of particulates from a gas stream comprising a major portion of oil and a minor portion of thickener, said adhesive coating having a viscosity of approximately 12.5.
